(19) United States
(12) Patent Application Publication
(10) Pub. No.: US 2011/0213971 A1
(43) Pub. Date: Sep. 1, 2011

(54) METHOD AND APPARATUS FOR PROVIDING RIGHTS MANAGEMENT AT FILE SYSTEM LEVEL

(75) Inventors: Mustafa Ilhan GUREL, Espoo (FI); Janne Mantyla, Espoo (FI); Sami Lehtisaari, Nokia (FI); Tommi Von Hertzen, Pori (FI); Elena Reshetova-Gillet, Helsinki (FI); Juhani Makela, Helsinki (FI)

(73) Assignee: Nokia Corporation, Espoo (FI)

(21) Appl. No.: 12/715,106

(22) Filed: Mar. 1, 2010

(51) Int. Cl. H04L 9/32; G06F 21/24

(52) U.S. Cl. 713/165

(57) ABSTRACT

An approach is presented for providing rights management at file system level. A virtual file system rights management application receives a request to access a protected file. The rights management application binds the access request to the protected file in the file system, determines credentials associated with the request for accessing the protected file according to the binding and causes, at least in part, verification of the credentials according to a rights management system associated with the protected file. Based, at least in part, on the determination, the rights management application causes decryption of the protected content.

### BACKGROUND

Network service providers and device manufacturers are continually challenged to deliver value and convenience to consumers by, for example, providing compelling network services. In particular, many of these network services rely on the web-based technologies and supporting communication networks, leading to a great increase in the popularity of such services. As a result, more and more users are benefiting from online data storage and retrieval as well as from online services such as those providing access to digital media (e.g., movies, music, books, magazines, etc.). Furthermore, users and service providers trust online storage devices and servers with their data and applications to be protected from unauthorized use, distribution, and/or access. In order to protect information, various digital rights management (DRM) systems (e.g., PlayReady, Content-Scrambling System (CSS), Adobe Protected Streaming, etc.) and device security frameworks (e.g., Symbian and Maemo 6 Platform Security Frameworks, etc.) have been developed that provide information security and access rights management using technologies such as data encryption, password protection, licenses, etc. However, because of the variety and continuing development of such DRM systems and frameworks, device manufacturers, developers of applications, and service providers face significant technical challenges to providing consistent use and implementation of these technologies across multiple applications, platforms, devices, etc.

### SOME EXAMPLE EMBODIMENTS

Therefore, there is a need for an approach for providing rights management at a file system level, so that application developers need not to consider any specific rights management technology while developing code.

According to one embodiment, a method comprises receiving a request at a file system to access a protected file. The method further comprises binding the access request to the protected file in the file system. The method also comprises determining credentials associated with the request for accessing the protected file according to the binding. The method further comprises causing, at least in part, verification of the credentials according to a rights management system associated with the protected file. The method also comprises causing, at least in part, decryption of the protected file based, at least in part, on the verification.

According to another embodiment, an apparatus comprising at least one processor, and at least one memory including computer program code, the at least one memory and the computer program code configured to, with the at least one processor, cause, at least in part, the apparatus to receive a request at a file system to access a protected file. The apparatus is also caused to bind the access request to the protected file in the file system. The apparatus is further caused to determine credentials associated with the request for accessing the protected file according to the binding. The apparatus is also caused to cause, at least in part, verification of the credentials according to a rights management system associated with the protected file. The apparatus is further caused to cause, at least in part, decryption of the protected file based, at least in part, on the verification.

According to another embodiment, a computer-readable storage medium carrying one or more sequences of one or more instructions which, when executed by one or more processors, cause, at least in part, an apparatus to receive a request at a file system to access a protected file. The apparatus is also caused to bind the access request to the protected file in the file system. The apparatus is further caused to determine credentials associated with the request for accessing the protected file according to the binding. The apparatus is also caused to cause, at least in part, verification of the credentials according to a rights management system associated with the protected file. The apparatus is further caused to cause, at least in part, decryption of the protected file based, at least in part, on the verification.

According to another embodiment, an apparatus comprises means for receiving a request at a file system to access a protected file. The apparatus also comprises means for binding the access request to the protected file in the file system. The apparatus further comprises means for determining credentials associated with the request for accessing the protected file according to the binding. The apparatus also comprises means for causing, at least in part, verification of the credentials according to a rights management system associated with the protected file. The apparatus further comprises means for causing, at least in part, decryption of the protected file based, at least in part, on the verification.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of providing rights management at file system level, according to one embodiment;

FIG. 1B is a diagram depicting communication among a file system and a rights management application, according to one embodiment;

FIG. 2 is a diagram of the components of rights management application, according to one embodiment;

FIG. 3A is a flowchart of a process for providing rights management at file system level, according to one embodiment;

FIG. 3B is a flowchart of a process for file decryption, according to one embodiment;

FIG. 4 is a diagram of steps of the process of providing rights management at file system level, according to one embodiment;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for providing rights management at file system level are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “protected file” refers to any type of digital or electronic file that has been protected using one or more digital rights management (DRM) systems or security frameworks in, for instance, a computing and/or communication environment. In one embodiment, a file may be a data (content) file and/or an executable file (e.g., an application or other binary file). Although various embodiments are described with respect to files, it is contemplated that the approach described herein may also be used with any other type of protected information or data (e.g., data streams, broadcasts, etc.).

In addition, DRM technology refers to any means for controlling use of digital content by preventing unauthorized manipulation (e.g., accessing, copying, converting, etc.) of the content. In one embodiment, DRM technologies may be implemented at a hardware level (e.g., secret key stored as a hardware component assigned at the time of manufacturing) and/or software level (e.g., algorithmically determined secret key). For example, some early DRM technologies for management of access rights to films played on DVD players used encryption algorithms (e.g., CSS encryption) and required device manufacturers to sign license agreements that include restrictions against including certain features in their devices that could be used for extracting copies of the films. Another example DRM system is the PlayReady system, which is a platform independent digital rights management for devices (e.g., portable devices) that can provide rights management for groups of devices sharing the same license and allows license keys to be embedded in the protected files. Although various embodiments are described with respect to the PlayReady system, it is contemplated that the approach described herein is applicable to any type of DRM or security framework.

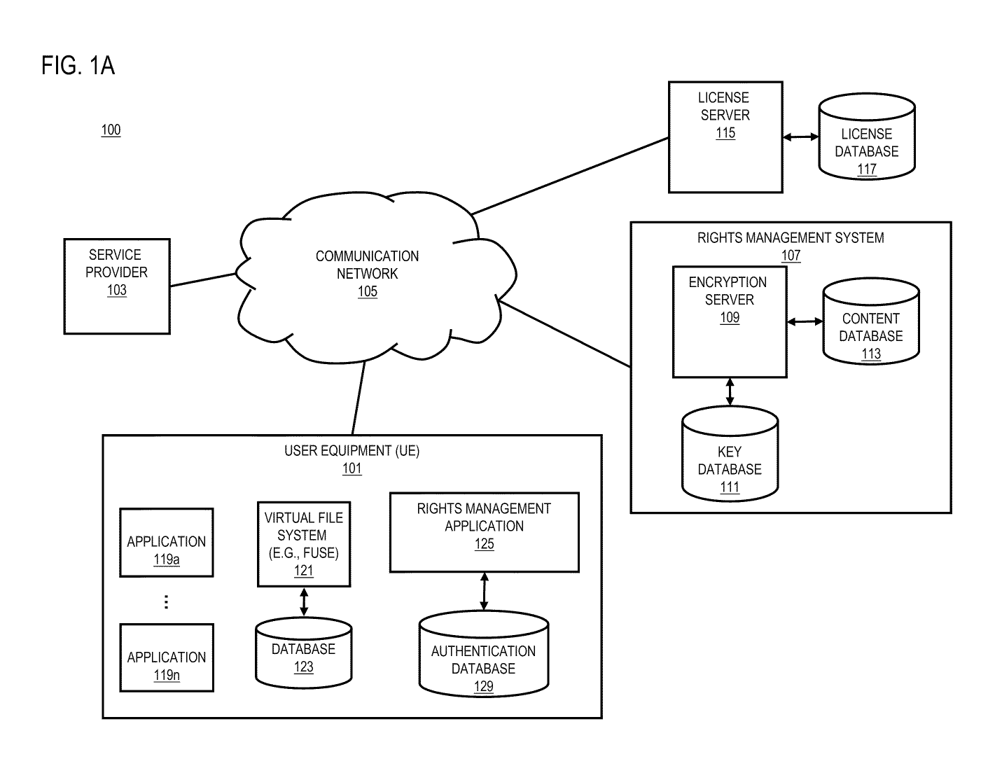

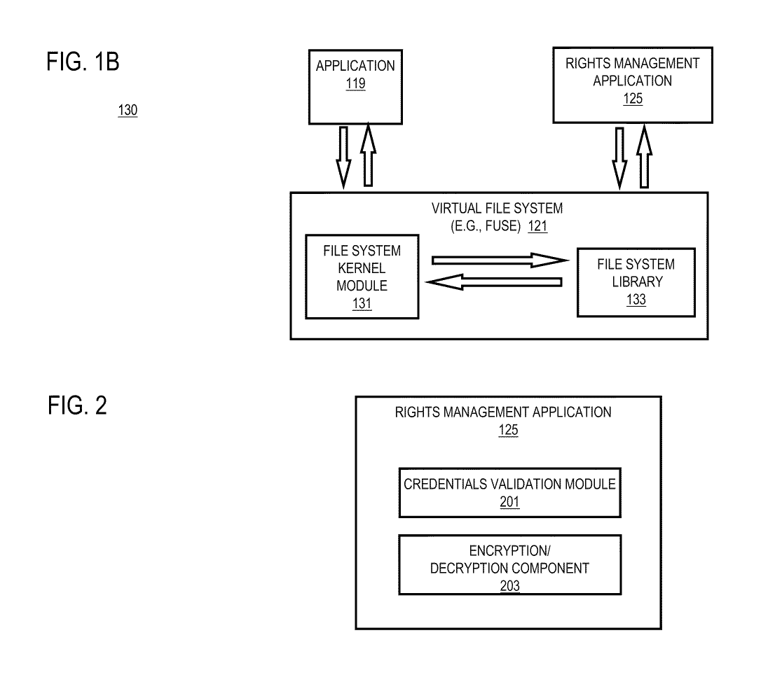

FIG. 1A is a diagram of a system capable of providing rights management at file system level, according to one embodiment. As noted previously, hardware manufacturers, copyright holders, and publishers commonly use various types of access control technologies to impose limitations on the usage of files and devices. For example, content providers (e.g. music industry, video industry, etc.) and application providers (e.g. software industry) often use these technologies to protect against unauthorized access, use, or distribution to their products (e.g., media files, applications, data, etc.). Historically, the use of protection schemes (e.g., DRM systems, security frameworks, etc.) has been implemented at the application level by using a combination of encrypted content and corresponding client applications. In other words, to implement any particular control technology, the application used to access the protected file generally has to be aware of the DRM system being used to protect or encrypt the content of interest. For example, each rights management technology may require a certain Application Programming Interface (API) to be used while developing code for the client application that manipulates the protected content. In one example, to play media files encrypted using the PlayReady system, the application developer has to include code in the application to link to PlayReady APIs for authenticating access requests, decrypting protected content, etc. This application-level approach to DRM places considerable burden on application developers to specifically tailor their applications based on the DRM technology that is to be supported. Moreover, when implementing multiple control technologies or when such systems are updated frequently, the programming burden on the developers can become even more daunting. This burden can ultimately discourage the development of applications that take advantage of protected content.

To address this problem, a system 100 of FIG. 1A introduces the capability to provide rights management operations at the file system level. More specifically, instead of including or linking to a rights management system on an application-by-application basis, the system 100 enables a client application to request access to protected content from the file system itself. In this way, the client application need not be aware of or incorporate code related to the specific technology used to protect a particular file. Instead, the client application can access the protected file by initiating a file operation request (e.g., to open or otherwise access the requested file) to a DRM or security technology enabled file system. By way of example, such a file system includes access to the DRM subsystem (e.g., the PlayReady system) so that the file system can authenticate the application for access to the protected and then decrypt the protected content in the file for transfer to the requesting application. It is noted that for a device to be able to access protected content with valid credentials, having a valid license is required.

In one embodiment, the file system is a virtual file system that is used together with a rights management system to provide access to protected files (e.g., when there is a valid license on the user's device) without an application accessing the protected files knowing or implementing details of underlying rights management technology. In other words, the application need not know that it is requesting a protected file. Instead, the underlying file system or virtual file system accesses file using the appropriate DRM system and returns the unprotected file content to the application if the application has the appropriate authorization or authentication. Such a virtual file system facilitates access control for protected files of different types (e.g., content files, executable files, etc.) using different protection methods (e.g., password, encryption, license, etc.). For example, it is noted that under the traditional application-level approach, an executable file cannot generally be protected with encryption without significant changes to the loader because the executable itself may have to be opened first to determine whether it is protected. Other approaches based on commercial obfuscation may be able to protect executable files to some extent, but these protections can often be broken through reverse engineering. With the system-level approach described herein, access control technology can be extended to executable files because the file system would be able to authenticate access to the file without first accessing it. Furthermore, this virtual file system enables code developers to write rights management aware applications without having to know what API or DRM technology to use. This is because the virtual file system, acting as an interface between the application and the rights management system, automatically selects the required API.

In a computing environment, files are generally stored and organized using methods referred to as file systems. File systems may, for instance, use a data storage device such as a hard disk or CD-ROM and involve maintaining the physical location of the files, they might provide access to data on a file server by acting as clients for a network protocol (e.g., NFS, SMB, or 9P clients), or they may be virtual and exist only as an access method for virtual data (e.g., procfs). More formally, a file system can be a special-purpose database for the storage, organization, manipulation, and retrieval of data.

As noted, the approach described herein can also use a virtual file system. By way of example, a virtual file system (e.g., Filesystem in a Userspace (FUSE)) may be implemented as an abstraction layer on top of a file system to allow applications to access different types of files organized by the file system in a uniform way; that is without being aware of file location, type, format, access method or even the file system. A virtual file system is an interface between the kernel (e.g. the operation system) and the file system. Therefore, support for new file systems can be added to the kernel by following the terms of the virtual file system.

Current rights management technologies do not provide file protection through virtual file systems. For instance, even though a virtual file system masks file system details such as physical characteristics of the files from users and applications, the details of rights management and access protection control introduced by each rights management system still need to be handled by each application. For example, if an application needs to access three files where the first file is password protected, the second file is encrypted using technology A, and a third file encrypted using technology B, the application typically must have access to the password and decryption keys for both technologies A and B in order to be able to gain access to the three files. This may cause considerable amount of extra processing spent on gaining access to a file before the application can actually use the content.

As shown in FIG. 1A, the system 100 comprises a user equipment (UE) 101 having connectivity to a service provider 103 via a communication network 105. Further, the UE 101 and service provider may communicate with a rights management system 107 utilizing the communication network 105 to implement security schemes on protected content or files. In one embodiment, the rights management system 107 provides protection for data provided to a UE 101 by a service provider 103 via the security schemes. The service provider 103 may be a provider of content, such as an online music store that allows users to download music, an online video store that allows users to download video, an online gaming store that allows users to download games, an online application store that allows users to download applications, etc. For example, the provider 103 may provide unlimited downloads of a media item (e.g., audio or video) for a fixed monthly subscription fee, a onetime download with a onetime fee, a predetermined download volume for a fixed fee, or any combinations thereof.

The rights management system 107 may be designed as a component of the service provider 103 or have connectivity to the service provider 103 via the communication network 105. As shown, the rights management system 107 includes an encryption server 109 to, for instance, generate the initial encryption to protect content files. For example, when a subscriber requests protected music files, the encryption server 109 can encrypt the content file before the system 107 delivers the content. By way of example, the protection for the content can include a key based system, where a key database 111 may be utilized to encrypt and decrypt content from a content database 113. Data encryption is a way for increasing security of the data. In order for the encrypted content to be decrypted by an authorized entity, the encryption is performed based on a certain set of rules. Further, in order for the authorized entity to be able to convert the encrypted data back into the original content, the entity may need a guide (a key) for applying the decryption process on the encrypted data. In one embodiment, a key database 111 contains decryption keys. The content database 113 contains the content that the users would like to download from the service provider 103 (e.g., music tracks in the above example). The key database 111 and the content database 113 may be stored in any location or component with connectivity to the network 105 and accessed by the UE 101, service provider 103, the rights management system 107 or any other components of the system via the communication network 105. In certain embodiments, the encryption server 109 associates a master key to content before the content is delivered to the UE 101.

The UE 101 communicates with a license server 115 in order to be approved for accessing licensed services provided by the service provider 103. The services may include software packages, tools, etc. The license server 115 can issue a license to UE 101 after authenticating the UE 101. Additionally, the license server 115 can utilize a license database 117 to verify the validity of a UE's license. Once the UE's license is approved the license server 115 provides a token or a key to the UE 101 to enable the UE 101 to access and use the licensed services or content. In various embodiments, the license server 115 and the license database 117 may be located within the service provider 103, within the rights management system 107, or other component to system 100.

Further, the UE 101 may include one or more applications 119a-119n. The applications 119a-119n can include client applications that provide various services to the user of the UE 101, loader applications that load executable files to the UE 101 from another device in the communication network 105, a system process, or a combination thereof. The services may manipulate data locally stored on the UE 101, such as calendars, contact lists, etc. Further, the applications 119 may store associated content using a virtual file system 121. In one embodiment, the virtual file system 121 provides access to files protected according to one or more rights management technologies implemented by the rights management system 107 and/or unprotected files. Additionally, the application 119 may utilize remotely stored data to be downloaded into the UE 101 via the communication network 105 and stored in a database 123. The virtual file system 121 is an interface between applications 119-119n and the files stored in the database 123. The virtual file system 121 masks physical characteristics of the file system, such as size, type, location, etc. and allows the applications 119a-119n to access the data without need for any information about the physical characteristics or other attributes of files (e.g., security features, physical location on storage media, etc.).

In one embodiment, an application 119 sends a request to the virtual file system 121 to access a file in database 123 which is protected by a technology applied by the rights management system 107. The virtual file system 121 alerts the rights management application 125 to invoke relevant file operation bindings that link operations of the virtual file system 121 to the physical layer operations (not shown). In one embodiment, the rights management application 125 is an application executing in the virtual file system 121. In addition or alternatively, one or more functions of the rights management application 125 can be implemented in the kernel of the virtual file system 121. In certain embodiments, file operation bindings associate file operations (e.g., open, close, move, delete, etc.) with the rights management application 125. The rights management application 125 then verifies the credentials of the application 119a-119n. The credentials may include resource token(s) indicating that the application is allowed to access the protected content. Further, the rights management application 125 may locally verify the validity of received credentials utilizing a security framework on specific platform (e.g. Maemo 6 or Symbian). The security framework provides an authentication database 129 that may include credentials information that may be associated with the UE 101, the user, a user account, etc. that may be utilized to verify that the application 119, the UE 101, or the user has access to the file. In one embodiment, the rights management application 125 may communicate with the rights management system 107 and/or license server 115 to request an up to date version of the credentials. For example, the credentials information may include user account information for subscription based content. The credentials information may be utilized to determine whether the subscription is valid.

In one embodiment, following approval of the credentials, the rights management application 125 locally decrypts the requested file. The decrypted content will not be stored. However, the original encrypted file may be stored in the database 123 or in a separate storage within the virtual file system 121. The file may be stored for repetitive decryption or stored temporarily to be accessed for a limited time depending on the access restrictions setup for the UE 101 at the time of subscription and stored in the license database 117, or on the access rights determined by the rights management system 107 for the application 119a-119n and stored in the authentication database 129, or a combination thereof. Further, the decrypted file can be provided to the application 119. In certain scenarios, the decrypted file is provided to the application 119 in the form of a buffer of the decrypted content.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

By way of example, the UE 101 and rights management system 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the rights management application 125 and the rights management system 107 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

FIG. 1B is a diagram depicting communication among a file system and a rights management application, according to one embodiment. File systems are in charge of storing, organizing, manipulation and retrieval of files in devices (e.g., the UE 101). The files may be of various types such, as executable or data files. A file system provides easy access to files for processes and their components. The file system may use data storage devices, such as hard disks and compact disks, and maintain physical location of the files. Additionally, file systems maintain various data associated with the files such as the length, the last time modified, owner ID, access permission settings and so on. In the case of the virtual file system 121, the physical location of files on a storage device is replaced with virtual addressing of the virtual file system 121. In certain embodiments, the virtual file system can include a single file that can be used by an operating system to store files in space allocated within the file. In certain embodiments, the operating system and/or a file system associated with an operating system of the UE 101 can provide access to the files in the virtual file system 121 seamlessly to applications 119. The file system kernel module 131 in FIG. 1B is a component of the virtual file system 121 that bridges between the application 119 and the actual data processing performed in the operating system level (not shown).

The file system library 133 provides facilities to query and manipulate files in the virtual file system 121. The file system library may include calls that provide common functions, such as read, write, copy, delete, etc., to be used for data manipulation by the file system. The file system kernel module 131 invokes library calls and applies bindings on the files.

Each file system has its own standards for storing, organizing and manipulating files. Therefore, there are incompatibilities between the file systems that make it difficult for an application to access files under different file systems. A virtual file system 121, as described above in FIG. 1A, is an abstraction layer above the file system that sits between application 119 and the file system 131. The virtual file system 121 can provide the application 119 with uniform access to different file systems 131 (e.g., because of seamless access provided by the operating system). Therefore, the application 119 need not account for the differences between file systems 131. As an example, Filesystem in Userspace (FUSE) is an open source file system software that allows creating virtual file systems 121 without making changes in the kernel of the corresponding operating system. FUSE contains, at least in part, a library, a kernel module and an application that provides bindings for file system operations to the particular underlying file system 131. Operating as an abstraction layer, the virtual file system 121 can service or otherwise intercept file system operation requests from the application 119 to the file system 131.

In one embodiment, the virtual file system 121 allows applications 119 to access files that are protected by rights management technology without knowing the details of the rights management technology and its relevant application programming interfaces (APIs). When an application 119 requests access to a protected file in the virtual file system 121, a binding associated with the file causes the rights management application 125 to determine whether the application 119 can access the file. That is, in order to make sure that only those applications 119 with the required credentials can access to protected files, credentials of the application 119 is checked on the UE 101. The process of credentials verification is performed by the rights management application 125. In certain embodiments, the credentials of the UE 101 (e.g., if rights are tied to a particular device according to the digital rights management technology), the user (e.g., via user account information if the rights are tied to a user account), a combination thereof are utilized in determining access to the content based on the user or UE 101 instead of the application 119.

The UE 101 as described utilizes combined benefits of local rights management protection by the rights management application 125 and the virtual file system 121 together. The combination provides “right management technology awareness” for the virtual file system 121. A virtual file system 121 with rights management technology awareness can provide applications 119 with access to protected files whenever needed based on the assumption that a valid license exists and the application 119 has the required credentials. Otherwise, the rights management application 125 would prevent the access being granted to application 119. As such, when the rights management application 125 is forwarded a request to access a file from the virtual file system 121, the rights management application 125 verifies whatever credentials are required from the rights management technology used. For example, the rights management application 125 may have a key in the authentication database 129 associated with the file to provide access to the file. Further, the rights management application 125 may request updated credentials information (e.g., in the case of subscription based content or due to digital rights management technology) from the license server 115 and/or rights management system 107.

As noted previously, once the credentials are verified, the rights management application 125 can decrypt the file. Further, the rights management application 125 can provide the decrypted file to the virtual file system 121 and/or to the application 119. In certain embodiments, the file is provided to the application 119 as a buffer. For example, in the case that the application 119 requests to open a content file, the decrypted content can be buffered and provided as a stream to the application 119.

Normally, applications 119 that attempt to access protected files would need to be aware of the rights management technology imposed on the files. In one embodiment, this means that the application 119 needs to know which Application Programming Interfaces (APIs) to use to be able to access protected files. However, the use of the virtual file system 121 as described above enables application 119 to have transparent access to the protected files without having to know about the specific rights management technology. Access to protected files is controlled by rights management application 125 that utilizes the file system library 133 and grants access to protected files only to the applications 119 with sufficient credentials.

FIG. 2 is a diagram of the components of rights management application, according to one embodiment. By way of example, the rights management application 125 includes one or more components for providing rights management at the file system level. It is contemplated that the functions of these components may be combined in one or more components or performed by other components of equivalent functionality. In this embodiment, the rights management application 125 includes a credentials validation module 201, and an encryption component 203.

The credentials validation module 201 receives credentials associated with one or more applications 119a-119n that request access to one or more protected files stored in the database 123. The application credentials may include an identifier, an access code, or any digital document used for authentication and access control. Credentials bind an identity or an attribute to a user, the application 119, the UE 101, etc. Credentials of applications 119a-119n that are presented to the credentials validation module 201 are verified by the credentials validation module 201 module based on the contents of the authentication database 129. In certain embodiments, the authentication database 129 may include a key for authenticating the application 119 and then decrypting the requested file. In other embodiments, the authentication database 129 may include credentials (e.g., an user identifier, a UE identifier, etc.) to verify, via a rights management system 107, that the user, UE 101, application 119, or a combination thereof has sufficient rights to access the file. If the credentials are invalid for one or more of the requested protected files, the requesting application 119 is denied access to the files. Otherwise, if the provided credentials are valid, the access is granted. Following approval of the credentials the rights management application 125 sends a decryption requests for the requested files to the encryption/decryption component 203.

In one embodiment, the encryption/decryption component 203 may have the decryption key locally stored. In another embodiment, the encryption/decryption component 203 may obtain the decryption key by communicating with the rights management system 107 via the communication network 105 (e.g., by providing credentials using the credentials validation module 201). The encryption/decryption component 203 utilizes the decryption key to decrypt contents of the requested files. The decrypted files may be stored in the database 123 or in a separate storage within the UE 121. Additionally, the decrypted files may be stored for repetitive use or stored temporarily to be accessed for a limited time depending on the access restrictions setup for the UE 101 at the time of subscription and stored in the license database 117, or on the access rights determined by the rights management system 107 for the application 119a-119n and stored in the authentication database 129, or a combination thereof.

Following the completion of the decryption process, the rights management application 125 notifies the requesting application 119 that the requested files are ready for use. Further, the rights management application 125 provides the file and/or content associated with the file based on the requested file operation requested by the application 119. For example, if the requested file operation is a request to read the file, contents of the file, once decrypted, can be provided to the application 119. The contents of the file can be buffered and provided to application 119 using the path of the virtual file system 121. As noted previously, the application 119 need not be informed that the file was protected, decrypted, or was associated with digital rights management security.

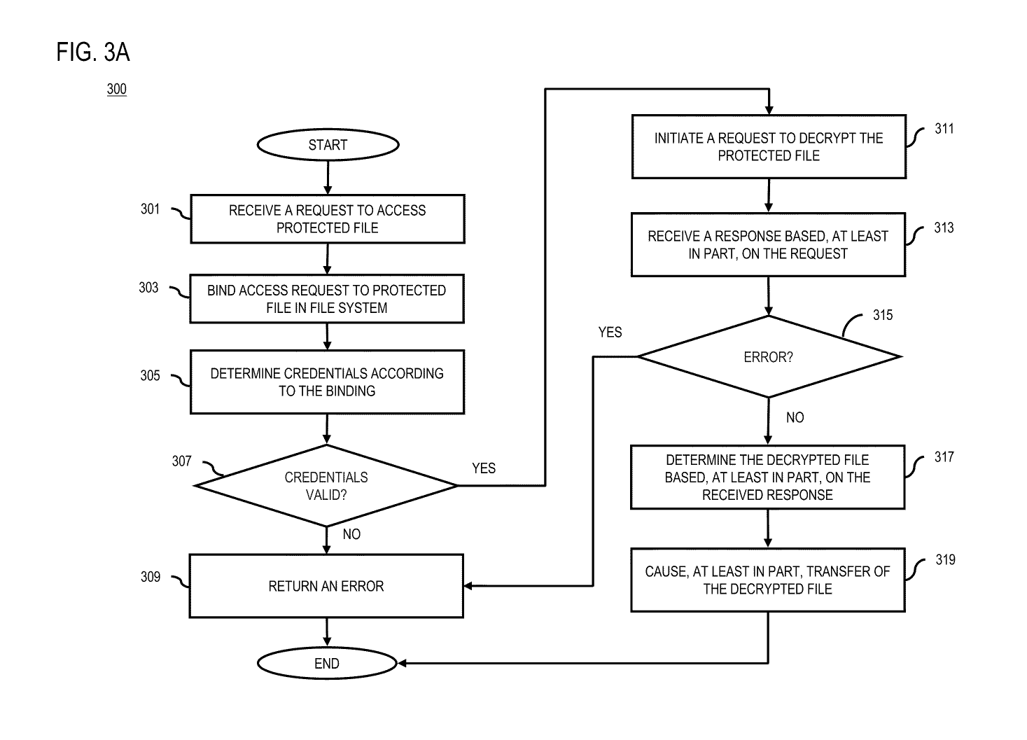

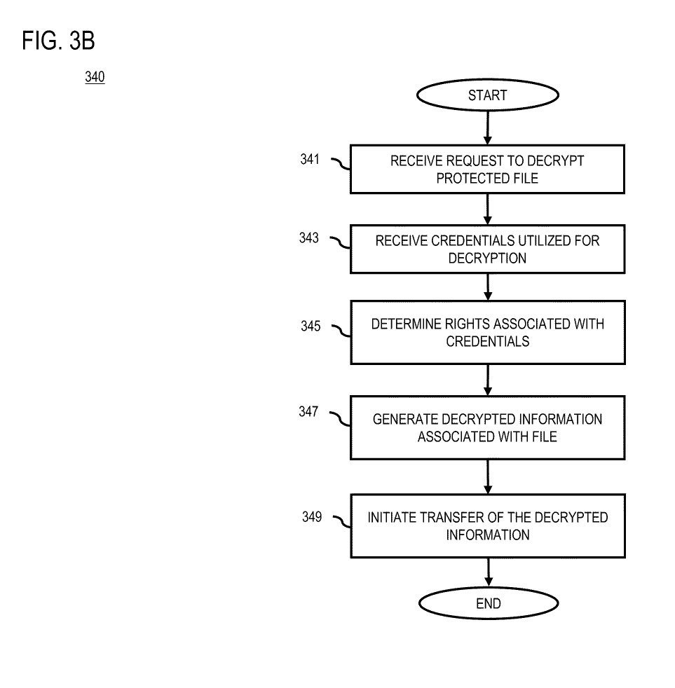

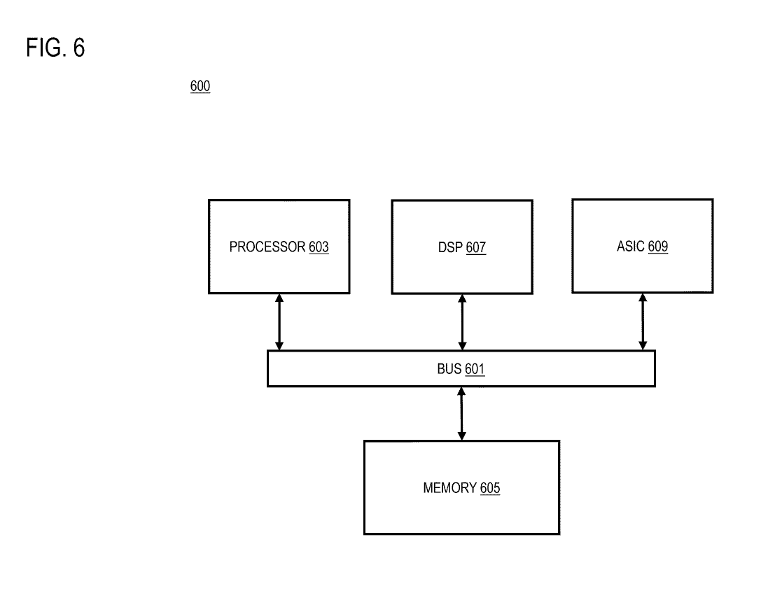

FIG. 3A is a flowchart of a process for providing rights management at file system level, according to one embodiment. In one embodiment, the rights management application 125 performs the process 300 and is implemented in, for instance, a chip set including a processor and a memory as shown in FIG. 6. In step 301, the virtual file system 121 receives a request from one or more of the applications 119a-119n to access a file that contains content protected by the rights management system 107. The requesting application can be a client application 119 provided to the user of UE 101 to be utilized for accessing services. For example, a client application 119 may be a music or video player. Additionally, the application 119 may be a component of another application or a system process. For example a component of a music player may need to access a protected musical track and create a compact version of the track for the purpose of saving space on the UE's memory. Furthermore, a system process may require access to a protected file for organizational purposes. For example, the application 119 may be a loader that needs to access the protected file for starting up the file itself (e.g., if the protected file is executable) or to utilize the protected file in running another process. The protected content may also include data such as text, sound, image, etc. Additionally, the protected content may include executable components such as word processors, sound players, image players, etc. In step 303, the virtual file system 121 invokes the rights management application 125 to bind the received request to protected file in file system. The binding process may include creating connection between the requested file and the operations involved in gaining access and manipulation of the file. The binding process may invoke restrictions imposed on the file such as credentials required for granting access to the file to a requesting application. The rights management application 125 may communicate with the license server 115 and query updates on the license required for accessing the file. In step 305, the rights management application 125 determines the credentials received from the requesting application and the required credentials determined during the binding process. In step 307, the rights management application 125 checks whether the credentials received from the requesting application match with the determined credentials or whether the credentials are otherwise authenticated. If the credentials do not match or cannot be authenticated, meaning that the requesting application does not have access rights to the file, an error message is issued and returned to the requesting application per step 309. In this case, access to the protected file is denied. The error message may appear on a monitor or other user interface to alert the user about inadequate credentials.

In case the credentials provided by the application match with the determined credentials, in step 311, the rights management application 125 sends a request to the encryption/decryption component 203 for the content of protected file to be decrypted. The request may include the credentials of the requesting application 119. At step 313, the rights management application 125 receives a response from the encryption/decryption component 203. The encryption/decryption component 203 verifies the UE 101 access right to the protected file by referring the authentication database 129. If the UE 101 has the access right (e.g. subscription or a license key), the encryption/decryption component 203 provides the encrypted content to the rights management application 125. Otherwise, in step 315, an error response is issued and the process ends in step 309. If no error condition occurs, in step 317, the rights management application 125 initiates transfer of the decrypted content of the protected file to the requesting application 119 per step 319. In one embodiment, the encryption/decryption component 203 may decrypt the requested file, store the requested file in a memory buffer and transfer the buffer information to the rights management application 125. The rights management application 125 can then transfer the received buffer information to the requesting application.

FIG. 3B is a flowchart of a process for file decryption, according to one embodiment. In one embodiment, the encryption/decryption component 203 performs the process 340 and is implemented in, for instance, a chip set including a processor and a memory as shown in FIG. 6. In step 341, the encryption/decryption component 203 receives a request from the rights management application 125 to decrypt a protected file. As noted previously, the encryption/decryption component 203 can receive the request from the virtual file system 121 in response to a file operation requested to be performed by an application 119.

Information owners or service providers may consider different levels of access right to the information. The credentials provided for a user, an application, a UE 101, a process or any other entity within the scope of the network may identify the authorization level for the entity. For example, an application 119 may only have the right to read a file or a portion of a file and not a write privilege, while another application may be authorized to read and write to the file. As for executable files, an application 119 may be authorized to configure or install an executable file while another application 119 may have the authorization to actually run the executable.

In one embodiment, the encryption/decryption component 203 may receive credentials from the credentials validation module 201, as per step 343, to determine the authorized access level to the protected file for the requesting application 119. In another embodiment, the level of access may be determined by the credentials validation module 201 which can then transfer the determined information to the encryption/decryption component 203. In yet another embodiment, a separate component of the rights management application 125 (not shown) may determine the authorization level for each application 119, monitor changes in authorization level and keep an up to date list of authorizations associated with the applications 119 in the UE 101. Further, the credentials validation module 201 can communicate with the rights management system 107 to obtain decryption information (e.g., a decryption key) associated with the credentials.

In step 345, the encryption/decryption component 203 determines the authorization level associated with the requesting application 119 based on the received credentials. The authorization level may be associated with a decryption key that allows for the decryption of the file. The encryption/decryption component 203 decrypts the requested file according to the access rights associated with the requesting application per step 345. The decryption can be accomplished utilizing a decryption key that may be provided with the credentials and/or stored in a location that the encryption/decryption component 203 can access. Then, the encryption/decryption component 203 generates decrypted information associated with the file (step 347). The decrypted information may be stored in a buffer.

In step 349, the encryption/decryption component 203 initiates transfer of decrypted information to the requesting application 119. As noted previously, the decrypted information can be stored in the buffer. As such, the buffer can be provided to the application 119. Further, the buffer can include all or a portion of the file.

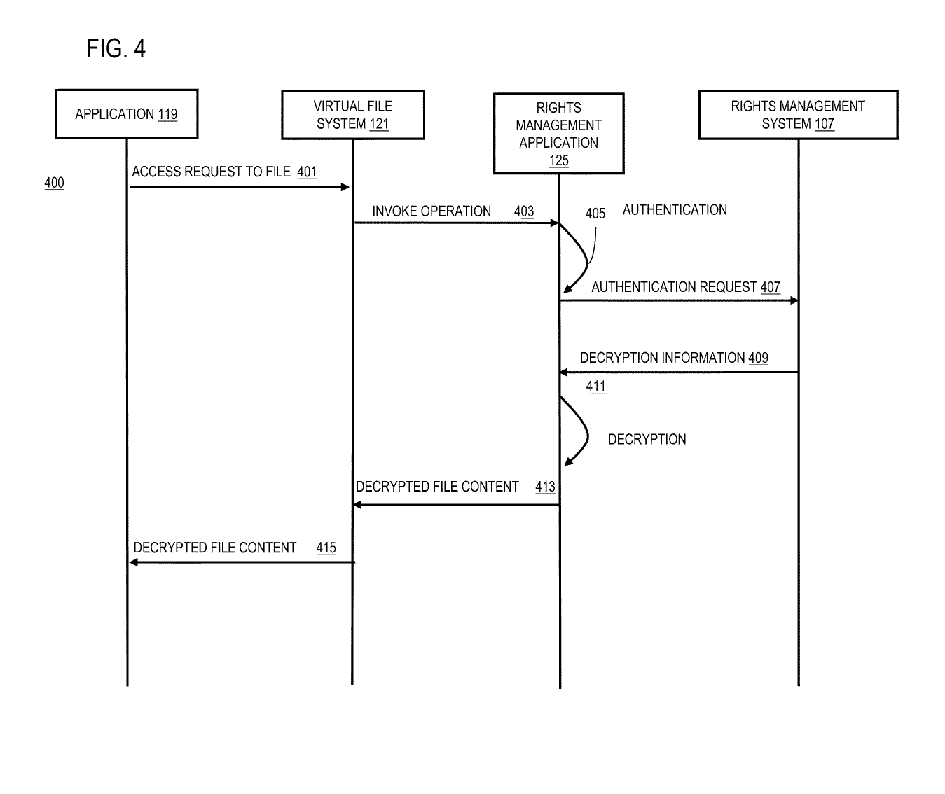

FIG. 4 is a diagram of steps of the process of providing rights management at file system level, according to one embodiment. A network process on the network is represented by endpoints of the vertical lines. A message passed from one process to another is represented by horizontal arrows. A step performed by a process is indicated by the text. The processes represented in FIG. 4 can be utilized to provide an application 119 access to decrypted information associated with a protected file. At step 401, the application 119 (e.g., a media player application, a game player application, etc.) requests access to a file. For example, the request may be to open or read the file. It is contemplated that the request may include any other file operation available under the file system 131, virtual file system 121, and/or operating system (not shown).

In one embodiment, the virtual file system 121 receives or intercepts the access request and determines whether the requested file is protected. If the requested file is protected, the virtual file system 121 can determine that the operation to be performed on the file (e.g., read or open) is bound to a rights management application 125. As such, the virtual file system invokes an operation binding to request that the rights management application 125 operate on the file (step 403).

The rights management application 125 receives the file operation request and determines whether the file can be accessed (step 405). Depending on the implemented digital rights management technology, the determination as to whether the file can be accessed can be based on one or more credentials. Examples of credentials can include credentials belonging to the application 119 (e.g., type of application, manufacturer, etc.), credentials belonging to the user (e.g., user account information, user identifier, etc.), credentials belonging to the UE 101 (e.g., a manufacturer serial number, phone number associated with the UE 101, etc.) or the like. Credentials can be linked by the rights management application 125 to decryption information (e.g., a decryption key) that can be utilized to decrypt the file. Further, the rights management application 125 can request decryption information from a rights management system 107 (step 407). The authentication request may include the credentials.

The rights management system 107 receives the credentials and determines whether the decryption information should be provided to the rights management application 125. For example, the rights management system may not provide a new key to a rights management application 125 if a review of the credentials indicates that the user's subscription to a service providing content in the file has expired. If this is indicated, the decryption information can be determined to be an error message. Otherwise, the decryption information may include a means for decrypting the file (e.g., a decryption key). As noted previously, in the case of a subscription, the decryption key can be limited to work for a certain time period. Then, at step 409, the rights management system 107 returns the decryption information 409.

The rights management application 125 receives the decryption information. If the decryption information includes an error message, the file is not decrypted and an error is returned to the virtual file system 121 and application 119. If the decryption information includes a means for decrypting the file, at step 411, the file or a portion of the file is decrypted. Then, the content of the file or a portion of the content is transferred to the virtual file system 121 (step 413). As indicated previously, the decrypted content or the portion of the decrypted content can be transferred via a buffer. Then, the virtual file system 121 provides the application 119 with the information requested (e.g., a response to the access request) (step 415).

The processes described herein for providing rights management at file system level may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

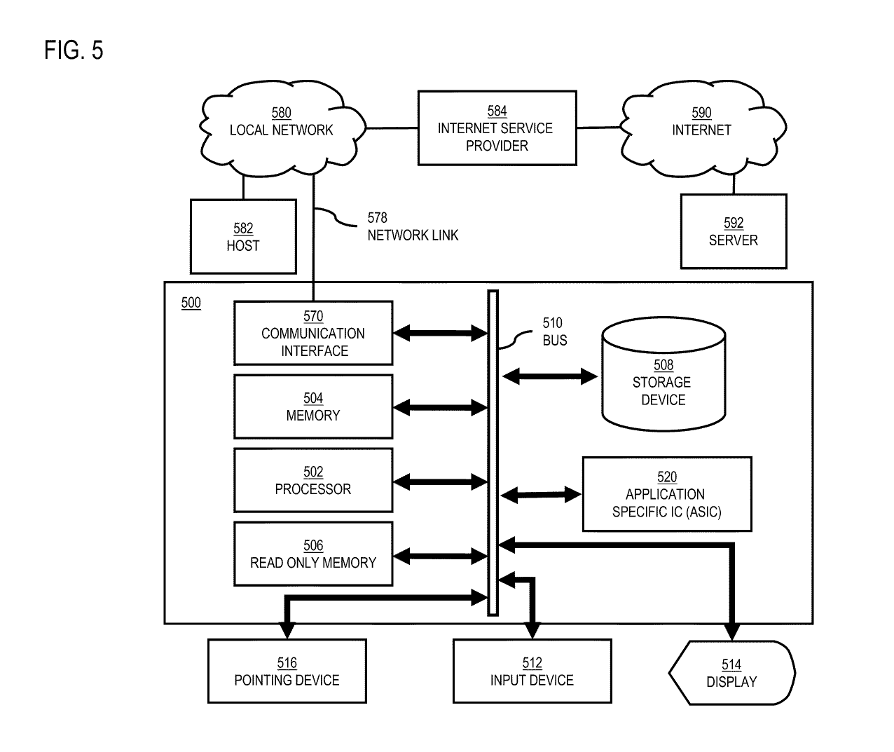

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to provide rights management at file system level as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of providing rights management at file system level.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to providing rights management at file system level. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or other dynamic storage device, stores information including processor instructions for providing rights management at file system level. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for providing rights management at file system level, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT) or a liquid crystal display (LCD), or plasma screen or printer for presenting text or images, and a pointing device 516, such as a mouse or a trackball or cursor direction keys, or motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of application specific ICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for providing rights management at file system level for the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to provide rights management at file system level as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of services. Chip set or chip 600, or a portion thereof, constitutes a means for performing one or more steps of providing rights management at file system level.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to provide rights management at file system level. The memory 605 also stores the data associated with or generated by the execution of the inventive steps.

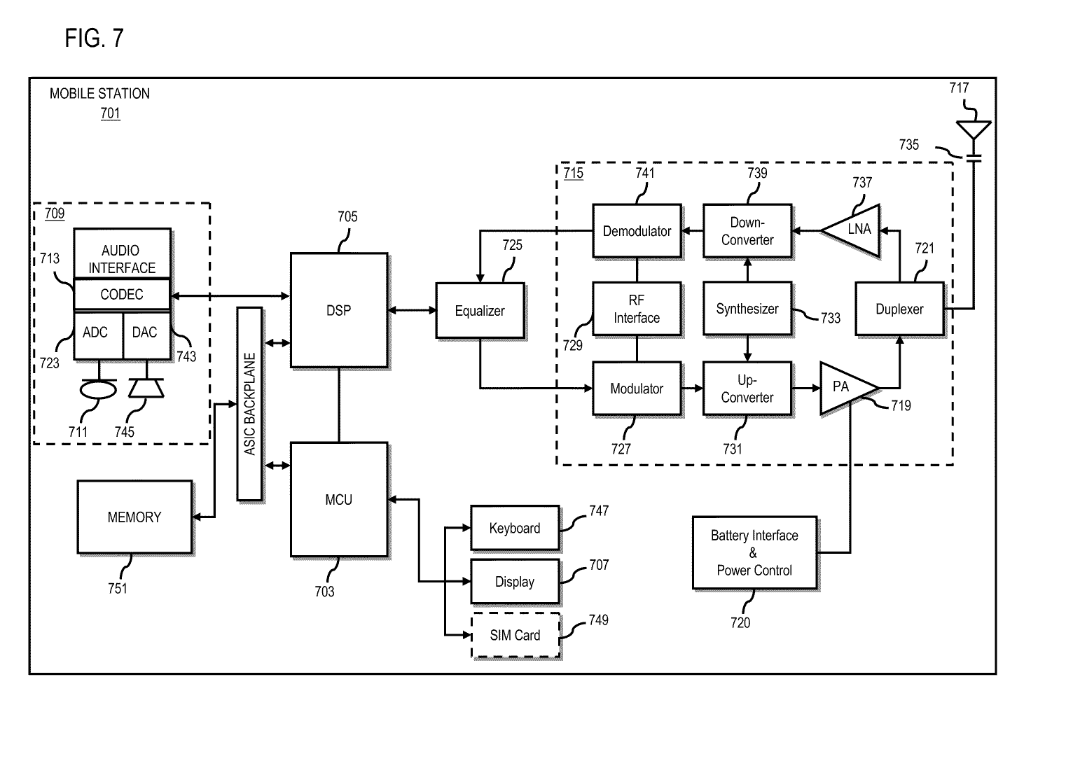

FIG. 7 is a diagram of exemplary components of a mobile terminal (e.g., handset) for communications, which is capable of operating in the system of FIG. 1A, according to one embodiment. In some embodiments, mobile terminal 700, or a portion thereof, constitutes a means for performing one or more steps of providing rights management at file system level. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of providing rights management at file system level. The display 7 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703—which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to provide rights management at file system level. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request at a file system to access a protected file;
binding the access request to the protected file in the file system;
determining credentials associated with the request for accessing the protected file according to the binding;
causing, at least in part, verification of the credentials according to a rights management system associated with the protected file; and
causing, at least in part, decryption of the protected file based, at least in part, on the verification.

2. A method of claim 1, wherein the request is received from an application, a loader, a system process, or a combination thereof, the method further comprising:
causing, at least in part, transfer of decrypted content from the protected file to the application, the loader, the system process, or the combination thereof.

3. A method of claim 1, further comprising:
initiating a rights management application,
wherein the rights management application verifies the credentials and causes decryption of the protected file based, at least on the verification.

4. A method of claim 1, further comprising:
determining whether the verification of the credentials has failed; and
returning an error status based, at least in part, on the failure.

5. A method of claim 1, wherein the rights management system is hardware-based, software-based, or a combination thereof.

6. A method of claim 1, wherein the file system is a virtual file system.

7. A method of claim 1, wherein the protected file is a data file, an executable file, or a combination thereof.

8. A method of claim 1, further comprising:
storing decrypted content of the protected file in a buffer; and
providing access to the buffer in response to the request.

9. An apparatus comprising:
at least one processor; and
at least one memory including computer program code,
the at least one memory and the computer program code configured to, with the at least one processor, cause the apparatus to perform at least the following,
receive a request at a file system to access a protected file;
bind the access request to the protected file in the file system;
determine credentials associated with the request for accessing the protected file according to the binding;
cause, at least in part, verification of the credentials according to a rights management system associated with the protected file; and
cause, at least in part, decryption of the protected file based, at least in part, on the verification.

10. An apparatus of claim 9, wherein the request is received from an application, a loader, a system process, or a combination thereof, the apparatus is further caused to:
cause, at least in part, transfer of decrypted content from the protected file to the application, the loader, the system process, or the combination thereof.

11. An apparatus of claim 9, wherein the apparatus is further caused to:
initiate a rights management application,
wherein the rights management application verifies the credentials and causes decryption of the protected file based, at least on the verification.

12. An apparatus of claim 9, wherein the apparatus is further caused to:
determine whether the verification of the credentials has failed; and
return an error status based, at least in part, on the failure.

13. An apparatus of claim 9, wherein the rights management system is hardware-based, software-based, or a combination thereof.

14. An apparatus of claim 9, wherein the file system is a virtual file system.

15. An apparatus of claim 9, wherein the protected file is a data file, an executable file, or a combination thereof.

16. An apparatus of claim 9, wherein the apparatus is further caused to:
store decrypted content of the protected file in a buffer; and
provide access to the buffer in response to the request.

17. A computer-readable storage medium carrying one or more sequences of one or more instructions which, when executed by one or more processors, cause an apparatus to at least perform the following steps:
receive a request at a file system to access a protected file;
bind the access request to the protected file in the file system;
determine credentials associated with the request for accessing the protected file according to the binding;
cause, at least in part, verification of the credentials according to a rights management system associated with the protected file; and
cause, at least in part, decryption of the protected file based, at least in part, on the verification.

18. A computer-readable storage medium of claim 17, wherein the apparatus is caused, at least in part, to further perform:
cause, at least in part, transfer of decrypted content from the protected file to the application, the loader, the system process, or the combination thereof.

19. A computer-readable storage medium of claim 17, wherein the apparatus is caused, at least in part, to further perform:
initiate a rights management application,
wherein the rights management application verifies the credentials and causes decryption of the protected file based, at least on the verification.

20. A computer-readable storage medium of claim 17, wherein the apparatus is caused, at least in part, to further perform:
determine whether the verification of the credentials has failed; and
return an error status based, at least in part, on the failure.
